(19) United States
(12) Patent Application Publication
(10) Pub. No.: US 2014/0006472 A1
(43) Pub. Date: Jan. 2, 2014

(54) Locating a Device

(71) Applicant: David Van Brink, Santa Cruz, CA (US)

(72) Inventor: David Van Brink, Santa Cruz, CA (US)

(21) Appl. No.: 13/536,429

(22) Filed: Jun. 28, 2012

(51) Int. Cl. G06F 15/16

(52) U.S. Cl. 709/201

(57) ABSTRACT

Various embodiments relate to methods of locating a secondary device associated with a user terminal. In one or more embodiments, the method receives, at an interface of the user terminal, location information of one or more secondary devices associated with the user terminal. The location information defines the physical spatial location of the secondary device relative to a reference location at the user terminal. A software application is executed at the user terminal and has access to the reference location and is configured to process data pertaining to the secondary device. The location information is supplied to the software application and the software application processes the data using the location information.

### BACKGROUND

A user terminal such as a personal computer, in a conventional set-up, has a single screen. In more recent times it has become more common for two or more screens to be used to display a single image. An example configuration is shown in FIG. 1a. In FIG. 1a, a user terminal 10 has a primary screen 12 and a secondary screen 14. When two or more screens are used, a user of the user terminal 10 can configure the two displays to show a continuous desktop image that extends across both screens. Macintosh computers developed by Apple Inc. are just one example of a user terminal that may be configured in this way. The operating system Mac OS X enables a user of a Macintosh computer to manually arrange multiple screens in a control panel. This will now be described with reference to FIG. 1b.

FIG. 1b illustrates a control panel 100 that can be accessed by a user through appropriate menu selections. Control panel 100 allows a user to configure a first screen represented by block 102 and a second screen represented by block 104. As shown in FIG. 1b, when configuring the two screens the Mac OS X operating system of the Macintosh computer assumes that the two screens are positioned in the same plane, are adjacent to each other such that they form a contiguous surface, and have two of their straight edges aligned vertically, and the operating system controls the display of information on the two screens based on these assumptions. However it is often the case that the two screens will not have this specific arrangement, and thus the operating system will display content on the screens in a manner that is not tailored to the specific orientation and position of the screens, thereby disturbing the image for the viewer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide an Application Programming Interface (API) on a user terminal so that a software application executed at the user terminal knows the location of one or more devices connected to the user terminal for processing data pertaining to the one or more devices.

In one or more embodiments, an operating system executed on a processor on the user terminal is arranged to receive the location information of one or more devices connected to the user terminal. The software application executed at the user terminal obtains the location information by sending a query to the operating system. The API handles the query sent from the software application to the operating system, such that it provides the requested location information to the software application.

In various embodiments, the location information can be used by the software application in many different applications as indicated more fully in the following.

### BRIEF DESCRIPTION OF THE DRAWINGS

For a better understanding of the described embodiments and to show how the same may be put into effect, reference will now be made, by way of example, to the following drawings in which:

FIG. 1a shows a computer configuration;

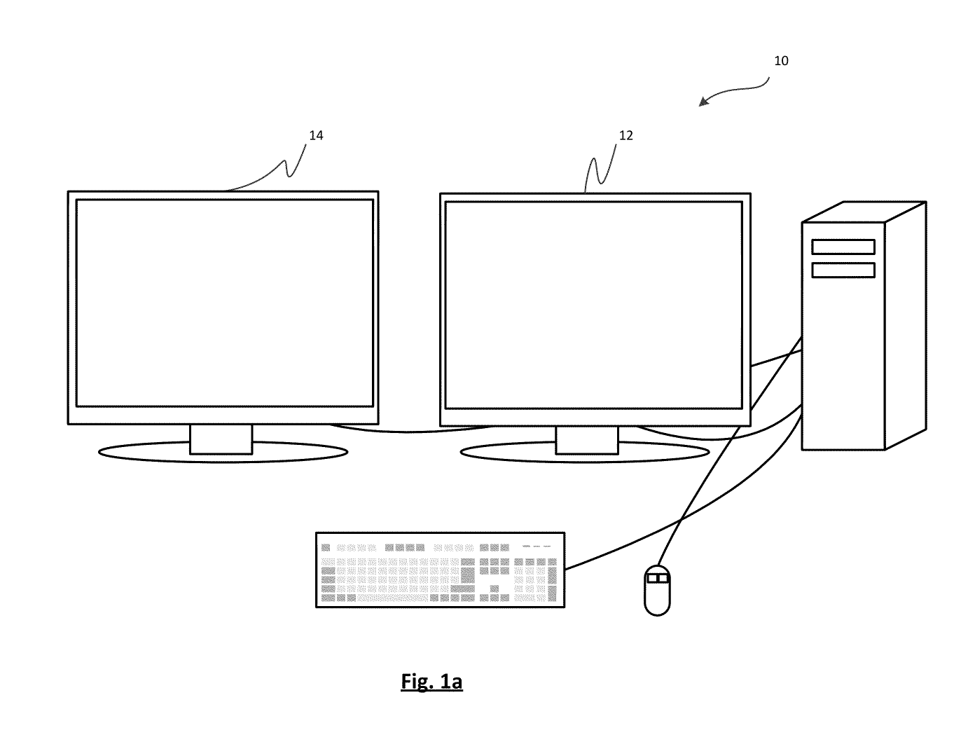

FIG. 1b shows a control panel for configuring multiple computer screens;

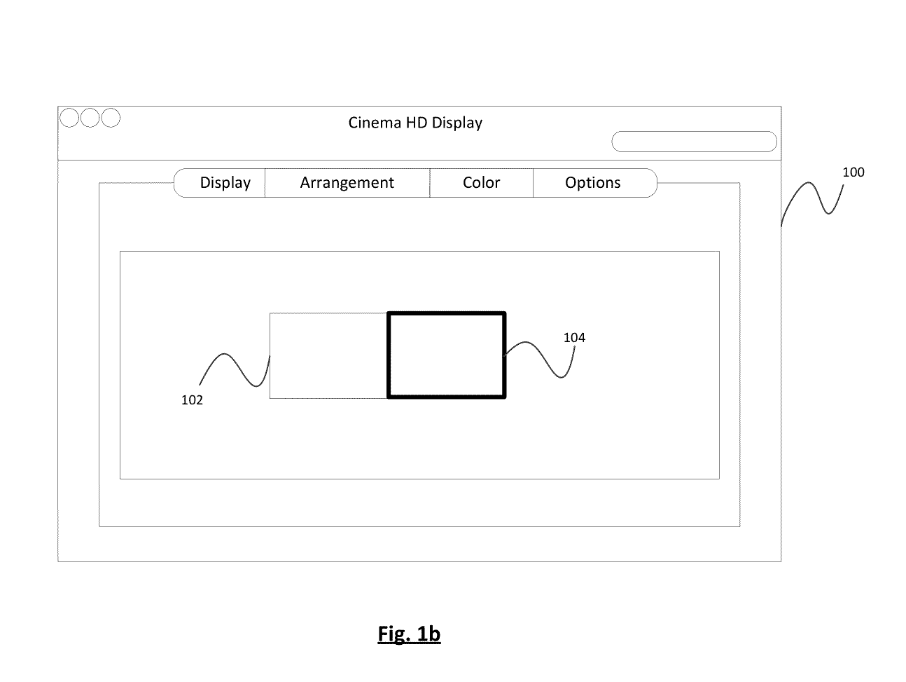

FIG. 2 shows a schematic view of a user terminal;

FIG. 3 shows a flowchart of a process for processing data.

### DETAILED DESCRIPTION

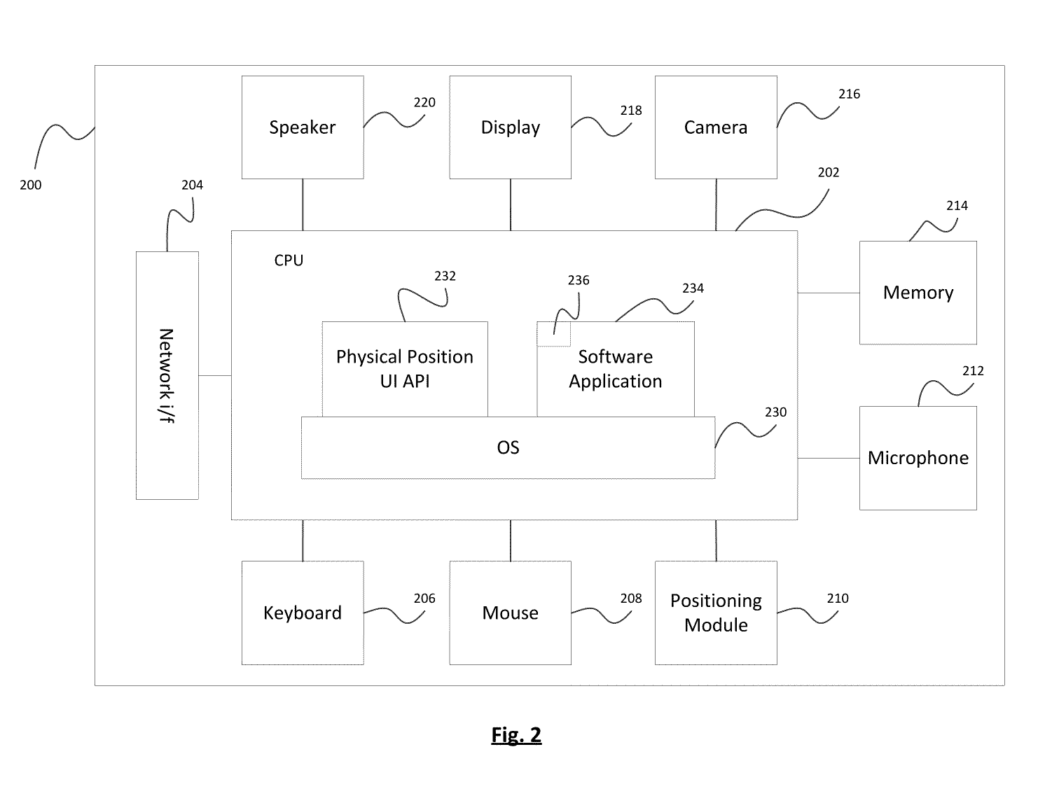

Reference is now made to FIG. 2, which illustrates a user terminal 200 according to one or more embodiments. The user terminal may be, for example, a mobile phone, a personal digital assistant (“PDA”), a personal computer (“PC”) (including, for example, Windows™, Mac OS™ and Linux™ PCs), a tablet computer, a gaming device, a television, or other embedded device.

The user terminal 200 comprises a CPU 202, to which is connected a display 218 such as a screen. It will be appreciated that block 218 may represent a plurality of screens connected to the CPU 202. Appropriate user input selections may be received by a user of the user terminal 200 touching the one or more screens. The CPU 202 may be connected to other input devices such as a keyboard 206 and a pointing device such as a mouse 208. Also connected to CPU 202 are speakers 220, a microphone 212 and camera 216 (commonly known as a web camera or Webcam). It will be appreciated that the microphone block 212 may represent a plurality of microphones, the camera block 216 may represent a plurality of camera, the display block 218 may represent a plurality of displays, and the speaker block 212 may represent a plurality of speakers. It will also be appreciated that one or more of the microphone 212, camera 216 and speakers 220 may be integrated into the display 218, or alternatively be external devices connected to the user terminal 200. The CPU 108 may also be connected to a network interface 204 for communication with a network (not shown).

FIG. 2 also illustrates an operating system (“OS”) 230 executed on the CPU 202. The OS 230 is arranged to receive location information of at least one of the microphone 212, camera 216, or speakers 220. When display block 218 comprises a primary display and a secondary display, the OS 230 is also arranged to receive location information of the secondary display. The microphone 212, camera 216, speakers 220 and secondary display will be referred to hereinafter as secondary devices. The term “secondary device” is used herein to denote a physical device connected to the CPU which exchanges data with the CPU. A secondary device may be connected to the user terminal via a wired or wireless connection. To clarify, location information defines the physical position of a secondary device in the spatial domain of the user terminal 200, relative to the user terminal. The OS 230 is also arranged to receive orientation information and physical size information of one or more of the secondary devices.

The CPU 202 is further connected to a positioning module 210 which is configured to determine location information of one or more of the devices, the operation of the positioning module 210 is described in further detail later.

As shown in FIG. 2, running on top of the OS 230 is a software application 234 and a physical position application programming user interface API 232.

User terminal 200 further comprises memory 214 such as an electronic erasable and programmable memory (EEPROM, or “flash” memory) coupled to the processor 202. The memory is arranged to store code arranged to be executed on the processor 202 to implement the software application 234. This code 234 may be loaded into the memory 214 using a computer readable medium as is known in the art. Alternatively the code arranged to be executed on the processor 202 to implement the software application 234 may be temporarily downloaded as Flash or JavaScript running in a web page.

In one embodiment the code is communications code arranged to be executed on the processor 202, and configured so as when executed to engage in communications over a network using network interface 204. The communications code preferably comprises a communication client application for performing communications such as voice or video calls with other user terminals. These communications may be conducted over a packet based network such as the Internet and/or a mobile cellular network and/or a circuit switched network such as the public switched telephone network (PSTN) using network interface 204. In addition to voice and video communication, the client may also set up connections for other communication media such as instant messaging (“IM”), SMS messaging, file transfer and voicemail.

In another embodiment, the code comprises a stand-alone image capturing application not configured to engage in communications over a network.

Alternatively, image capturing code can form part of the communication client application.

The physical position user interface API 232 provides an interface between the operating system 230 and a user interface component 236 of the software application 234. The physical position user interface API 232 is arranged to handle queries sent from the software application 234 to the operating system 230, such that it can provide location information of a secondary device associated with the user terminal to the software application 234 for use when the software application processes data pertaining to the device.

In some cases, the same API might report the location of the user/users of the user terminal 200, as well (For example if a Kinect or other device has gathered that information).

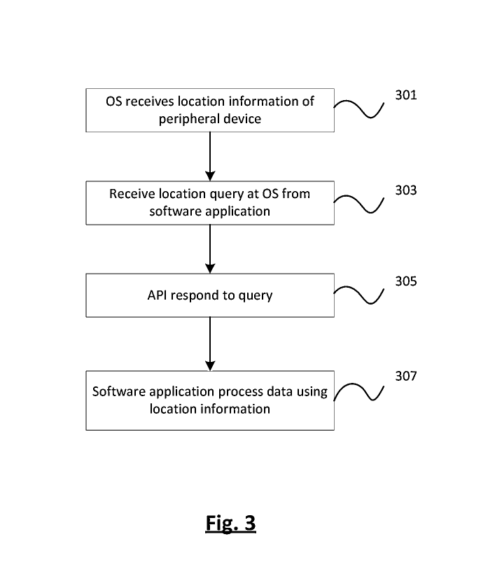

With reference to FIG. 3, a method of locating a secondary device and processing data using the location information will now be described.

At step 301 the OS 230 receives location information of one or more secondary devices associated with the user terminal 200. The location information may be expressed in metric units (for example centimeters) or imperial units (for example inches) and is expressed relative to a fixed part of the user terminal 200 such as a primary display.

The OS 230 may receive the location information in a number of ways.

In one method, the positioning module 210 is configured to determine a location of one or more of the secondary devices and supply this location information to the operating system 230. The positioning module 210 may implement one of a variety of different methods to determine the location of the secondary devices. These methods include using sonar, radar, near-field radio, an infrared signal or global positioning system technology (GPS). In this scenario, the secondary device is arranged to communicate the location information to the user terminal 200. The message communicated from the secondary device to the user terminal 200 may include an identifier so the user terminal 200 is able to determine which secondary device is reporting its position. The message may be communicated from the secondary device to the user terminal 200 using a wired or wireless connection. Such types of connections are well known in the art and are not described in detail herein.

In another method, a secondary device may act as a sensor to determine the location of another secondary device.

The camera 216 is one example sensor that may be used to determine the location of another secondary device. The camera 216 may be arranged to detect a visual signature of a secondary device. For example, the camera 216 may be arranged to detect the optical output of a screen of a secondary display or a lamp of a secondary device. In this example the OS 230 could present images or other changes on the optical output of a secondary device, and then analyze the camera image to find the expected display pattern. In another example, the camera 216 may be arranged to detect specific recognizable markers on the secondary device. The recognizable markers may include any machine-recognizable graphic such as a linear barcode or a two-dimensional barcode (i.e. a QR code). Multiple cameras could be used to increase accuracy or cover more area. Image analysis may also reveal the orientation of a secondary device.

The microphone (216) is another example sensor that may be used to determine the location of another secondary device. In one example, the OS 230 could present recognizable sounds on the speaker 220 or secondary display if speakers are integrated into the secondary display, and use the microphone 216 to search for these recognizable sounds.

The OS 230 may be configured to dynamically gather location information of the secondary devices. This allows the OS 230 to have accurate location information even if the position of the secondary devices changes.

In yet another method, a user control panel may be displayed on display 218 and used by a user of the user terminal 200 to manually inform the OS 230 of the locations of the secondary devices. The user control panel may also be used by a user of the user terminal 200 to manually inform the OS 230 of the physical size and orientation of the secondary devices. This manually entered information can be tagged with an indicator that informs the OS 230 that the information was obtained from a user input and is not necessarily accurate.

In the case, where one or more of the microphone 212, camera 216 and speakers 220 are integrated into the display 218, the OS 230 can retrieve fixed location, physical size, and orientation information of the secondary devices that results from the manufacture of the display. As a mere example, the user terminal 200 may be a laptop computer with a particular size screen with a camera 216 located ¼″ above the top edge of the screen, and centered. This fixed location information may be stored in memory 214 for access by the operating system.

Thus it can be seen that at step 301, the OS 230 may also receive physical size and orientation information of the secondary devices in addition to the location information. For example, The OS 230 may receive physical size information of a primary display and if connected, physical size information of a secondary display. As with the location information, the physical size information may be expressed in metric or imperial units.

At step 303, the OS 230 receives a location query sent from software application 234. The query is a request for location information and any other information which may be known regarding a secondary device such as its physical size, orientation and mode of the device.

At step 305, the software application user interface API 232 handles the query sent from the software application 234 to the OS 230, such that it provides the requested information of a secondary device associated with the user terminal to the software application 234.

At step 307, the software application 234 processes data pertaining to the secondary device using the requested information.

The various embodiments have a number of different applications. How the software application 234 may process data pertaining to the secondary device using the requested information in step 305 will now be described with reference to the following examples.

In one example, the software application may display an arrow pointing at the secondary device with a message. For example, where the secondary device is a microphone 212 the software application may display an arrow pointing at the microphone with a message saying “Speak in the microphone”, and where the secondary device is a camera 216, the software application may display an arrow pointing at the camera with a message saying “Smile for the camera!”.

Where the secondary device is a camera 216, by providing the camera location to the software application 234, the software application 234 is available to use the location information for a variety of purposes which improves the image capture usefulness. For example, in a multi-camera application, the software application 234 could use the location information to provide names for the secondary devices connected to the user terminal 200 i.e. default values like “left camera”, “right camera”, and “top camera”. With orientation data, the software application 234 can advise the user that a camera is presently pointed away from the user terminal 200.

In another example, where the secondary device is a camera 216, the software application may be arranged to capture image data and display a preview image on a display 218. Knowing the location of the camera 216 allows the software application 234 to display the preview image in a position on the display 218 close to the location of the camera 216. For example, if the camera 216 is positioned at the side of the display 218 and is orientated to capture image data of the user of the user terminal 200, the preview image can be presented at the side of the display 218 (close to the camera) so that the preview image is displayed on the display 218 close to where the user was looking when the camera captured the image data for the preview image. That is, the position of the preview image displayed on the display 218 is dependent on the location information of the camera 216.

In another example, the secondary device is a speaker 220, connected externally to the user terminal 200. Knowing the location of the speaker allows the software application 234 to change the volume and/or balance of the audio output from the speaker. That is, the software application may increase or decrease the volume of the audio output from the speaker in dependence on the distance between a reference location at the user terminal and the speaker. This enables the audio output from the speaker to be at a volume such that the audio information is easily heard by the user of the user terminal. This prevents a user having to manually change audio settings for the speaker when the speaker is moved to a different location in the user's environment.

In another example, the secondary device is a microphone 212, connected externally to the user terminal 200. Knowing the location of the microphone allows the software application 234 to change the input volume of the microphone. That is, the software application may increase or decrease the input volume of the microphone in dependence on the distance between a reference location at the user terminal and the microphone. That is, the further the microphone is placed from the reference location, the input volume of the microphone can be increased to improve the microphone's ability to capture input audio data. This prevents a user having to manually change audio settings for the microphone when the microphone is moved to a different location in the user's environment.

In another example, the secondary device is a secondary display connected to the user terminal 200 in addition to a primary display. Knowing the location of the secondary display allows the software application 234 to present a useful panoramic view that extends across the two displays, which is more accurate than one on an assumed contiguous planar arrangement. That is, the OS 230 displays content on the displays that is tailored to the specific position of the primary and secondary displays. For example, in an aircraft simulation, the view could be presented as through two screen “cockpit windows”. In this example, if the primary and secondary displays were some distance from each other, the software application 234 would not generate directly adjacent views but instead views appropriate to the position of the “windows”.

In another example where the secondary device is a secondary display connected to the user terminal 200 in addition to a primary display, knowing the actual location of the secondary display allows the software application 234 to display information on the secondary display to enhance a user's experience. For example, if the software application 234 determines that a secondary display is located at a distance further from a user than a primary display, the software application 234 may increase the size of text (i.e. font) or images that are displayed on the secondary display. This enables the information displayed on the secondary display to be sized so that the information is easily visible to the user of the user terminal. This prevents a user having to manually change display settings of the secondary display when the display is moved to a different location in the user's environment.

It will be appreciated that when primary display is connected to more than one additional display the location information can include location information of these additional displays.

While various embodiments have been particularly shown and described, it will be understood to those skilled in the art that various changes in form and detail may be made without departing from the scope of the claimed subject matter.

According to one embodiment there is provided a method of locating a secondary device associated with a user terminal, the method comprising: receiving at an interface of the user terminal location information of one or more secondary devices associated with the user terminal, said location information defining the physical spatial location of the secondary device relative to a reference location at the user terminal; executing a software application at the user terminal, the application having access to the reference location and configured to process data pertaining to the secondary device; and supplying said location information to the software application, said software application configured to process said data using the location information.

In one or more embodiments, the interface is a software application programming interface installed at the user terminal.

The application programming interface is installed on an operating system at the user terminal, the application programming interface arranged to supply said location information to the software application in response to a query sent from the software application.

The method may further comprise determining the location information at the user terminal and supplying the location information to said interface, wherein the step of determining the location information comprises: using a positioning module; or analyzing, at the user terminal, data pertaining to the secondary device captured by one or more cameras; or analyzing, at the user terminal, data pertaining to the secondary device captured by one or more microphones.

The method may further comprise receiving user-entered location information at the user terminal and supplying the location information to said interface.

Where the secondary device is integrated into the user terminal, the method may comprise comprising automatically determining the location information at the user terminal and supplying the location information to said interface.

In one or more embodiments, the data pertaining to the secondary device includes one of: image data captured by a camera associated with the user terminal; audio data captured by a microphone associated with the user terminal; audio data output from a speaker associated with the user terminal; and image data generated to a secondary display associated with the user terminal.

The software application may generate an indication on a display of the user terminal, identifying the location of the secondary device.

In one example, where the data pertaining to the secondary device is image data captured by a camera associated with the user terminal, the software application may be configured to process said data using the location information to display the image data on a display of the user terminal at a position close to the camera.

In one example, where the data pertaining to the secondary device is audio data output from a speaker associated with the user terminal, the software application may configured to process said data using the location information to control the volume of the audio data based on the location information.

In one example, where the data pertaining to the secondary device is image data generated to a secondary display associated with the user terminal, the software application may be configured process said data using the location information to control the size of text displayed on the secondary display based on the location information.

The method may further comprise receiving at the interface of the user terminal orientation information of the secondary device, and supplying said orientation information to the software application, said software application configured to process said data using the orientation information.

According to another embodiment, there is provided a user terminal associated with a secondary device, the user terminal comprising: an interface configured to receive location information of one or more secondary devices associated with the user terminal, said location information defining the physical spatial location of the secondary device relative to a reference location at the user terminal; and a processor for executing a software application, the application having access to the reference location and configured to process data pertaining to the secondary device, wherein the interface supplies the location information to the software application, said software application configured to process said data using the location information.

The user terminal may further comprise a primary display and the secondary device may be at least one of a camera, microphone, a speaker and a secondary display.

The user terminal may further comprise a positioning module for determining said location information.

The positioning module may comprise a signaling based positioning system configured to determine the location information and supply the location information to said interface, wherein the signaling based positioning system uses at least one of radar; sonar; near-field radio; an infrared signal. Alternatively, the positioning module may be a global positioning system.

The user terminal may further comprise input means configured to receive user-entered location information.

In one or more embodiments, the software application is a communication client application or an image capturing application.

According to another embodiment, there is provided a user terminal comprising: a primary display; a secondary display; a software application programming interface configured to receive location information of the secondary display, said location information defining the physical spatial location of the secondary device relative to a reference location at the user terminal; and a processor for executing a software application, the application having access to the reference location and configured to process image data generated to the secondary display, wherein the interface supplies the location information to the software application, said software application configured to process said data using the location information, wherein the application programming interface is installed on an operating system at the user terminal, the application programming interface arranged to supply said location information to the software application in response to a query sent from the software application.

What is claimed is:

1. A method of locating a secondary device associated with a user terminal, the method comprising:
receiving, at an interface of the user terminal, location information of one or more secondary devices associated with the user terminal, said location information defining a physical spatial location of the secondary device relative to a reference location at the user terminal;
executing a software application at the user terminal, the application having access to the reference location and configured to process data pertaining to the secondary device; and
supplying said location information to the software application, said software application configured to process said data using the location information.

2. The method of claim 1, wherein the interface is a software application programming interface installed at the user terminal.

3. The method of claim 2, wherein the application programming interface is installed on an operating system at the user terminal, the application programming interface arranged to supply said location information to the software application in response to a query sent from the software application.

4. The method of claim 1, further comprising determining the location information at the user terminal and supplying the location information to said interface, wherein said determining the location information comprises:
using a positioning module; or
analyzing, at the user terminal, data pertaining to the secondary device captured by one or more cameras; or
analyzing, at the user terminal, data pertaining to the secondary device captured by one or more microphones.

5. The method of claim 1, 2 or 3 further comprising receiving user-entered location information at the user terminal and supplying the location information to said interface.

6. The method of claim 1, wherein the secondary device is integrated into the user terminal, the method further comprising automatically determining the location information at the user terminal and supplying the location information to said interface.

7. The method of claim 1, wherein the data pertaining to the secondary device includes one of:
image data captured by a camera associated with the user terminal; audio data captured by a microphone associated with the user terminal;
audio data output from a speaker associated with the user terminal; or
image data generated to a secondary display associated with the user terminal.

8. The method of claim 1 wherein the software application generates an indication on a display of the user terminal, identifying the location of the secondary device.

9. The method of claim 7, wherein the data pertaining to the secondary device is image data captured by a camera associated with the user terminal, said software application configured to process said data using the location information to display the image data on a display of the user terminal at a position close to the camera.

10. The method of claim 7, wherein the data pertaining to the secondary device is audio data output from a speaker associated with the user terminal, said software application configured to process said data using the location information to control the volume of the audio data based on the location information.

11. The method of claim 7, wherein the data pertaining to the secondary device is image data generated to a secondary display associated with the user terminal, said software application configured process said data using the location information to control the size of text displayed on the secondary display based on the location information.

12. The method of claim 1, the method further comprising receiving at the interface of the user terminal orientation information of the secondary device, and supplying said orientation information to the software application, said software application configured to process said data using the orientation information.

13. A user terminal associated with a secondary device, the user terminal comprising:
an interface configured to receive location information of one or more secondary devices associated with the user terminal, said location information defining the physical spatial location of the secondary device relative to a reference location at the user terminal; and
a processor for executing a software application, the application having access to the reference location and configured to process data pertaining to the secondary device, wherein the interface supplies the location information to the software application, said software application configured to process said data using the location information.

14. The user terminal according to claim 13, wherein the user terminal comprises a primary display and the secondary device is at least one of a camera, microphone, a speaker or a secondary display.

15. The user terminal according to claim 13, further comprising a positioning module for determining said location information.

16. The user terminal according to claim 15, wherein the positioning module comprises a signaling based positioning system configured to determine the location information and supply the location information to said interface, wherein the signaling based positioning system is configured to optionally use at least one of radar; sonar; near-field radio; or an infrared signal.

17. The user terminal according to claim 15 wherein the positioning module is a global positioning system.

18. The user terminal according to claim 13, comprising input means configured to receive user-entered location information.

19. The user terminal according to claim 12, wherein the software application is communication client application or an image capturing application.

20. A user terminal comprising:
a primary display;
a secondary display;
a software application programming interface configured to receive location information of the secondary display, said location information defining the physical spatial location of the secondary display relative to a reference location at the user terminal; and
a processor for executing a software application, the application having access to the reference location and configured to process image data generated to the secondary display, wherein the interface is configured to supply the location information to the software application, said software application configured to process said data using the location information,
wherein the application programming interface is installed on an operating system at the user terminal, the application programming interface arranged to supply said location information to the software application in response to a query sent from the software application.
